(19) United States
(12) Patent Application Publication
(10) Pub. No.: US 2009/0188572 A1
(43) Pub. Date: Jul. 30, 2009

(54) PRESSURE REGULATOR

(75) Inventor: Christian BASLER, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: TESCOM EUROPE GMBH & CO. KG, Selmsdorf (DE)

(21) Appl. No.: 12/360,405

(22) Filed: Jan. 27, 2009

(30) Foreign Application Priority Data
Jan. 28, 2008 (EP) 08 001 518.3

(51) Int. Cl. F16K 31/12

(52) U.S. Cl. 137/505

(57) ABSTRACT

The invention relates to a pressure regulator with a rotatable hand wheel for setting the pressure, with which the hand wheel is provided with a detent mechanism.

### CROSS REFERENCE TO RELATED APPLICATIONS

This application claims the benefit of priority under 35 U.S.C. § 119 of European Patent Application EP 08 001 518.3 filed Jan. 28, 2009, the entire contents of which are incorporated herein by reference.

### FIELD OF THE INVENTION

The invention relates to a pressure regulator with a rotatable hand wheel for setting the pressure.

### BACKGROUND OF THE INVENTION

Such pressure regulators have been known and applied for some time now, in order to reduce an entry pressure to a lower exit pressure, and to maintain the exit pressure constant at a preset pressure. Usually, a rotatable hand wheel is provided for presetting the pressure, by way of whose rotation a spring is compressed to a greater or lesser extent and sets the pressure on account of its spring force.

### SUMMARY OF THE INVENTION

It is the object of the invention to improve such a pressure regulator in a manner such that it permits a more accurate setting ability of the pressure, and provides an improved feel to the user when setting the pressure.

According to the invention, with regard to the pressure regulator, the hand wheel is provided with a detent. This means that the user must overcome successive locking points on rotating the hand wheel. Thus there are a number of successive resistances which are to be overcome on rotation of the hand wheel. Thereby, the detents or resistances are preferably selected such that no large force is to be mustered for overcoming, but the individual detents are clearly perceptible to the user. A more delicate setting of the pressure is possible by way of this detent, since on rotating the hand wheel, the user has a better feel as to how far he has rotated the hand wheel or not.

Preferably, the detent mechanism has a regular division. I.e. the individual locking points or resistances are distributed regularly, in dependence on the rotary angle of the hand wheel, i.e. at regular angular intervals. A uniform setting of the pressure over the complete setting region of the pressure regulator is possible by way of this. However, it is also conceivable to design the distances of the locking points of the detents differently over the rotation angle, in order for example to give the user when setting a different feel to the setting in different pressure regions, depending on whether it is the case of a pressure region in which it requires coarser setting steps or finer setting steps. The division is preferably designed as small as possible for realising a fine setting.

Each locking step of the detent mechanism may preferably correspond to a predefined change of the set pressure. If the individual locking steps or locking points or resistances, which are to be overcome on rotating the hand wheel, are distributed at regular angular intervals over the rotation angle of the hand wheel, then, given a linear spring characteristic of the pressure regulator, the spring force of the spring in the pressure regulator will also change proportionally to the individual locking steps, so that the set pressure changes proportionally to the locking steps.

According to a preferred embodiment, the hand wheel is rotatable relative to a regulating housing and is provided on a side which faces the regulator housing, with at least one locking element. Moreover, with this preferred embodiment, at least one corresponding locking element is arranged on the regulator housing, such that on rotation of the hand wheel, it comes into engagement with the at least one locking element on the hand wheel. I.e. locking elements which lie opposite one another or face one another are formed on the hand wheel and regulator housing, and these locking elements come into contact or engagement with one another on rotating the hand wheel. These locking elements then disengage given a further rotation of the hand wheel. The locking elements thus form the locking points or resistances of the detent mechanism, which need to be overcome on rotating the hand wheel. Preferably, at least one of the locking elements, i.e. the locking element on the hand wheel or regulator housing, is designed in a resilient manner, so that on overcoming its spring force, this locking element again disengages from the corresponding opposite locking element and the locking point or resistance formed in this manner is overcome.

Preferably, with this embodiment, many successive locking elements or locking projections, which define the locking points or the detent, are formed either on the hand wheel or the regulator housing. I.e. preferably these locking elements or locking projections are distributed uniformly over the periphery or rotation angle of the hand wheel. Less locking elements, for example only one locking element, which thereby is designed preferably in a resilient manner, may be provided on the respective other opposite element (hand wheel or regulator housing).

Preferably, an annular corrugation is formed on a surface facing the regulator housing, with which corrugation at least one locking element on the regulator housing is engaged. The corrugation consists of a plurality of successive alternating raisings and deepenings, which may be formed in a surface of the hand wheel, in particular an inner surface facing the regulator housing. The raisings thereby define the individual locking points. A locking element which is arranged on the regulator housing engages into this corrugation, in a manner such that on rotation of the hand wheel, the raisings of the corrugation need to be overcome by the locking element. Thereby, the raisings and deepenings are consecutive along a circular line, wherein this circular line extends concentrically to the rotation axis of the hand wheel. I.e. raisings and deepenings alternate in the rotation direction of the hand wheel, in the corrugation, wherein a closed ring is preferably formed by the corrugation, so that the detent mechanism is also effective with more than one rotation of the hand wheel.

A reverse arrangement is alternatively also possible, with which an annular corrugation with which at least one looking element on the hand wheel is engaged, is formed on a surface of the regulator housing, which faces the hand wheel. The design of the corrugation thereby corresponds to the preceding description. Here, only one reverse arrangement is selected with which the corrugation is arranged on the regulator housing and the at least one locking element is arranged on the hand wheel.

Preferably, the corrugation is arranged on a surface extending normally to the rotation axis of the hand wheel. I.e. the corrugation is designed in the manner of a crown wheel toothing. The corresponding locking element, which engages with such a corrugation, then preferably extends parallel to the rotation axis of the hand wheel with such a corrugation, and in particular is designed in a resilient manner in this direction, in order to be able to overcome the raisings of the corrugation on rotation of the hand wheel. Alternatively, it is also possible to design the corrugation on a peripheral surface, for example an inner peripheral surface of the hand wheel, wherein then a corresponding locking element extends preferably essentially in the radial direction to the rotation axis of the hand wheel, and in particular is designed in a resilient manner in this direction.

The at least one locking element on the regulator housing or the at least one locking element on the hand wheel, are preferably designed as a ball locking element. This design in particular relates to that locking element which engages with stationary locking elements, such as with a corrugation for example. With a ball locking element, a locking ball is provided, which comes into contact with the corresponding locking element, for example with the corrugation. Thereby, the ball is mounted in a resilient manner such that it is movable in a direction transversely to the movement path of the locking elements, on rotating the hand wheel. Thus the locking ball may be axially displaced against the spring by a corrugation, when a raising of the corrugation is to pass the locking ball pass the raising and then enter into the subsequent deepening of the corrugation.

It is to be understood that it is sufficient to provide one locking element which engages with a corrugation on the respective other component. For example, for a more uniform force flow, it may however be preferable to provide several locking elements such as ball locking elements for example, which are further preferably distributed uniformly over the periphery about the rotation axis of the hand wheel.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a sectional view of a pressure regulator with a detent mechanism according to the invention; and

FIG. 2 is an enlarged view of the cut-out Z of FIG. 1.

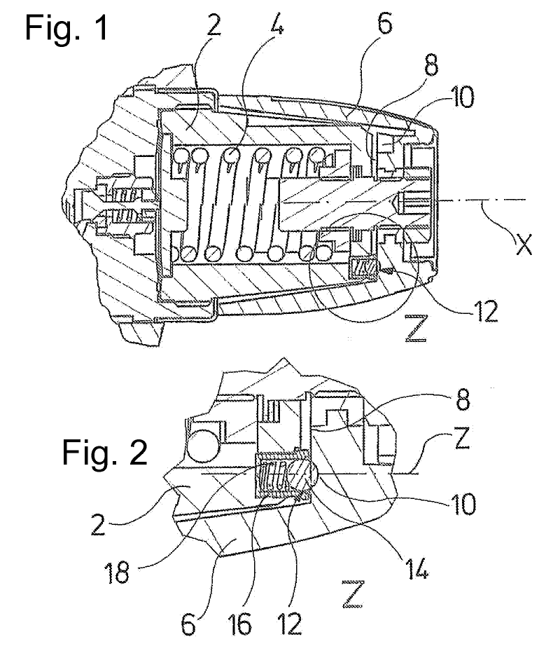

### DESCRIPTION OF THE PREFERRED EMBODIMENTS

Referring to the drawings in particular, the pressure regulator shown in the figure basically has a known construction. The pressure regulator has a regulator housing 2, in which the actual elements of the pressure regulator and in particular a spring 4 which sets the pressure via its spring force, are arranged. Moreover, a hand wheel 6 for presetting the pressure is arranged on the regulator housing 2, wherein the spring 4 in known manner is compressed to a different extent by way of rotating the hand wheel 6 about the rotation axis X, in order to change the spring force which sets the pressure. In the shown example, the hand wheel 6 is designed in a pot-like manner and engages over a front end of the regulator housing 2. A corrugation 10 extending annularly is formed on the inner end-face 8 of the hand wheel, said end-face facing the regulator housing 2 and extending normally to the rotation axis X. This corrugation comprises alternating raisings and deepenings, wherein these in the shown embodiment are formed by way of incorporating deepenings in the form of recesses into the end side 8. If the hand wheel 6 is manufactured of plastic, this corrugation may be introduced at the same time in a simple and inexpensive manner on injection moulding the hand wheel 6.

A ball locking element 12, which is engaged into the corrugation 10, is arranged on a position of the end-side of the regulator housing 2, which lies opposite the end-side 8 and the corrugation 10. The ball locking element comprises a locking ball 14 which is movably mounted in the direction of the axis Z, in a pot-like housing 16. Thereby, the locking balls 14 bear on a compression spring 18 arranged in the housing 16. The compression spring 18 is supported on the base of the housing 16 and presses the locking ball 14 into the corrugation 10, so that the locking ball 14 engages into this when a recess of the corrugation lies opposite the locking ball. If the hand wheel 6 is rotated further about the axis X, so that a raising of the corrugation 10 lies opposite the locking ball 14, the locking ball 14 is pressed against the spring 18 further into the housing 16, until the locking ball 14 may then enter into the subsequent deepening of the corrugation 10, when the hand wheel is rotated further. Thus, on rotation of the hand wheel 6, every time a raising of the corrugation passes the locking ball 14, a certain force is to be overcome, which is set by the compression force of the spring 18. This produces a feelable detent mechanism on rotating the hand wheel 6, which gives the user an improved feel on setting the pressure. The corrugation 10 thereby is designed such that a regular division is given, i.e. the raisings and deepenings of the corrugation alternate at regular angular intervals.

Only one ball locking element 12 is shown in the figure, but it is to be understood that one may also arrange more than one ball locking element on the end-side of the regulator housing 2, wherein these are then preferably uniformly distributed over the periphery of the longitudinal axis X. Alternatively, it would be possible to design the corrugation 10 on the inner peripheral surface of the hand wheel 6, and to arrange the ball locking element 12 such that its movement axis Z extends essentially radially to the longitudinal axis X, instead of parallel to it, as in the shown example.

While specific embodiments of the invention have been shown and described in detail to illustrate the application of the principles of the invention, it will be understood that the invention may be embodied otherwise without departing from such principles.

What is claimed is:

1. A pressure regulator comprising:
a rotatable hand wheel for setting the pressure;
a detent mechanism provided with said hand wheel.

2. A pressure regulator according to claim 1, with which the detent mechanism has a regular division.

3. A pressure regulator according to claim 1, wherein each locking step of the detent mechanism corresponds to a predefined change of the set pressure.

4. A pressure regulator according to claim 1, further comprising:
a regulator housing with a regulator housing locking element, wherein:
said hand wheel is rotatable relative to said regulator housing;
said hand wheel is provided with a hand wheel locking element on a side facing said regulator housing with said regulator housing locking element and said hand wheel locking element comprising said detent mechanism; and
said regulator housing locking element is provided corresponding to said hand wheel locking element and is arranged on said regulator housing in a manner such that on rotation of said hand wheel results in said regulator housing locking element coming into engagement with said hand wheel locking element.

5. A pressure regulator according to claim 4, wherein an annular corrugation is formed on a surface of the hand wheel, said annular corrugation facing said regulator housing, with which corrugation said regulator housing locking element is in engagement.

6. A pressure regulator according to claim 4, wherein an annular corrugation, with which hand wheel locking element is engaged, is formed on a surface of said regulator housing, which faces said hand wheel.

7. A pressure regulator according to claim 5, wherein said corrugation is arranged on a surface extending normally to a rotation axis of said hand wheel.

8. A pressure regulator according to claim 6, wherein said corrugation is arranged on a surface extending normally to a rotation axis of said hand wheel.

9. A pressure regulator according to claim 4, wherein said regulator housing locking element or said hand wheel locking element comprises a ball locking element.
